(19) United States
(12) Patent Application Publication
(10) Pub. No.: US 2008/0217303 A1
(43) Pub. Date: Sep. 11, 2008

(54) OPTICAL FIBER FUSION SPLICE DEVICE FOR USE IN CONFINED SPACES

(75) Inventor: James E. Blagrave, Frisco, TX (US)

Correspondence Address: BRACEWELL & GIULIANI LLP, P.O. BOX 61389, HOUSTON, TX, 77208-1389, US

(73) Assignee: Lockheed Martin Corporation

(21) Appl. No.: 11/456,017

(22) Filed: Jul. 6, 2006

(51) Int. Cl. B23K 9/00

(52) U.S. Cl. 219/121.45; 219/121.46

(57) ABSTRACT

Optical Fiber Fusion Splice Device that includes a receiving mechanism, internal chamber, alignment mechanism and circuitry, and an optical welding module. The receiving mechanism is operable to receive a pair of optical fibers that have been prepared for splicing. An internal chamber serves to isolate the optical fibers from an external environment. An alignment circuitry and mechanism aligns the first optical fiber to the second optical fiber within the internal chamber, wherein a welding module optically welds or fuses the aligned optical fibers. This welding module may employ an arc between a pair of electrodes, or other device such as an Edison coil, to heat and fuse the optical fibers. The internal chamber may be coupled to an evacuation system or positive displacement system in order to evacuate or pump volatile or contaminant-containing gases from the internal chamber prior to fusing the aligned optical fibers.

### TECHNICAL FIELD OF THE INVENTION

The present invention relates generally to optical fibers, and more particularly, to a system and method of fusing optical fibers.

### BACKGROUND OF THE INVENTION

Optical cables, which include one or more optical fibers, are used in a wide variety of applications including use as a key technical component in aircraft. These optical pathways may be used to carry large volumes of data over great distances, for example, or to efficiently transmit light from a light source to an area of interest. Optical fibers and cables are produced using precision manufacturing techniques and require exacting standards. Optical fiber can be thought of as a finely tuned instrument requiring care in production, handling, installation and use.

FIG. 1 depicts a cross-section of a typical optical fiber 10 having three main components. These components include: core 12, which carries the light to be transported within the optical pathway; cladding 14, which surrounds the core and typically has a lower refractive index in order to contain the light; and coating 16, which protects the fragile fiber within. Core 12 is the smallest and most fragile part of the optical fiber. The optical fiber's core is usually made of a glass or other like transparent material that is extremely pure. An extremely clear core is required to minimize transmission losses within the optical fiber. Cladding 14 surrounds and protects Core 12. Coating 16, which may be made of a plastic, acrylic or other like material, absorbs shocks, nicks, scrapes and even moisture to prevent damage to the cladding and core. Without the coating, the optical fiber is extremely fragile. Coating 16 is only protective and does not contribute to the light carrying ability of the optical fiber. Despite the presence of the Coating 16 around the optical fiber core, optical fibers may frequently be bent and damaged where they optically couple with a laser or other component.

FIG. 2 shows a typical unprotected optical fiber cable 24 that may be easily bent causing damage to the core. To repair damage caused by bending the fiber, the optical fibers may be repaired or spliced. The simplest type of optical cable is cordage and is used in connection with equipment and patch panels. The major difference between cordage and cables is that typically cordage has only one fiber buffer combination within the jacket, whereas optical cables generally have multiple fibers within a single jacket or multiple cords inside an outer jacket or sheath.

Optical cables typically include two or more optical fibers that have been bundled within a single cable. These cables may be used for data communications, imaging or the transmission of light. The type of signal being carried and the number of optical fibers within the optical cable are just two of the many considerations when selecting a cable for a specific application. Other factors may include tensile strength, temperature resistance, ruggedness, environmental extremes, appearance, durability and flexibility. The exact combination of these factors varies depending on the specific use of the optical cable to be installed.

An individual optical fiber within a cable may be contained within a buffer. A buffer surrounds the cable and provides a greater measure of protection as well as some tensile strength which may be useful when pulling the optical cable or when the cable is suspended. The buffering of an individual cable consists of a buffering layer that surrounds a number of individual fibers. Optical fibers may be loosely buffered or tightly buffered. Loose buffering allows the fiber room to move independently of the buffer and the rest of the cable. This is important when a cable may be subjected to extreme temperatures or excessive bending.

The optical fiber's light carrying abilities are threatened by poor handling, poor splices, damage from tools or accidents, and improper installation procedures that can damage or bend individual fibers. Extreme bending can severely increase attenuation within an optical fiber. When a fiber is bent too far or improperly aligned, light no longer reflects off the boundary between the core and the cladding but passes through and is absorbed within the cladding and coating.

Many installations or repairs require the joining of fibers within tight or confined spaces. This problem exists in the many confined spaces associated with production aircraft and the retrofit applications. There is no available tool with which optical fiber can be replaced (via splicing) without complete removal of the affected harness.

### SUMMARY OF THE INVENTION

The present invention provides an Optical Fiber Fusion Splice Device operable to be used within confined Spaces that substantially addresses the above identified needs as well as others. More specifically, the present invention provides an Optical Fiber Fusion Splice Device that includes a receiving mechanism, internal chamber, alignment mechanism and circuitry, and an optical welding module. The receiving mechanism is operable to receive a pair of optical fibers that have been prepared for splicing. An internal chamber serves to isolate the optical fibers from an external environment. An alignment circuitry and mechanism aligns the first optical fiber to the second optical fiber within the internal chamber, wherein a welding module optically welds or fuses the aligned optical fibers. This welding module may employ an arc between a pair of electrodes, or other device such as an Edison coil, to heat and fuse the optical fibers. The internal chamber may be coupled to an evacuation system or positive displacement system in order to evacuate or pump volatile or contaminant-containing gases from the internal chamber prior to fusing the aligned optical fibers.

In other embodiments, positive pressure may be used in order to replace the internal atmosphere within the chamber with an inert gas such as argon or helium prior to fusing the aligned optical fibers. A cartridge mechanism may be employed wherein consumables associated with the optical splicing process are contained and pre-loaded within a cartridge in order to reduce process set up time, the time associated with set up, and the process itself. It may be loaded into the optical fiber fusion splicing system by a cartridge receiving mechanism that then is used to facilitate the fiber fusion process.

By designing a fusion splicer in a much smaller envelope than conventional applications, and specially designing the system to work in aircraft applications the fiber splicing application processes can be much improved, and time consumption as well as improvement in process can be the resultant payoff. Thus embodiments of the present invention will be able to splice optical fiber through the use of a cartridge loaded into the fiber fusion splice device. This device, which is then sealed through an evacuation process (to prevent any lingering outside fumes from affecting the necessary arc process for the fusion splice action). Once the sealing compartment is closed the technician will be able to select alignment, fusion and splice reinforcement operations which will be sequenced through a servo/software process.

Another embodiment provides a method with which to splice optical fibers. This may involve first preparing a pair of optical fibers that are to be spliced. This pair of optical fibers may then be located or received within an internal chamber of a fiber fusion splicing device. This chamber may then be sealed and isolated from an external environment. In order to prevent contamination from contaminant gases or potential hazards associated with volatile gases, the internal chamber may be evacuated, or the atmosphere therein may be displaced with an inert gas. The pair of optical fibers may then be aligned using the alignment mechanism, after which the first optical fiber may then be welded to or fused to a second optical fiber. Following the welding process, the optical weld may be reinforced using stiffeners or other like material and then graft with a protective sleeving in order to protect the fused fibers.

Yet another embodiment provides a reloadable or reusable cartridge mechanism that facilitates splicing optical fibers. This cartridge will contain a receiving mechanism, a receiver that is operable to receive the pair of optical fibers to be spliced. These optical fibers may be cleaned and cut in preparation for the weld prior to placement within the cartridge. Other embodiments may allow this process to occur within the cartridge. An alignment circuitry or mechanism within the cartridge may couple to an optical fiber fusion device in order to facilitate aligning the optical fibers within the cartridge. Electrodes or other mechanisms may penetrate the cartridge body in order to apply a welding process to the fibers. Additionally, consumables such as protective material and stiffening material within the cartridge may then be positioned and applied to the optical weld in order to protect it from an external environment once removed from the optical fiber fusion device.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 depicts the internal construction of a typical optical fiber;

FIG. 2 shows a typical unprotected fiber cable that may be easily bent causing damage to the core;

FIGS. 3A through 3E depict many intrinsic factors which may affect an optical splice;

FIGS. 4A through 4D depict many extrinsic factors which may affect an optical splice; and

FIG. 5 functionally depicts an optical fiber fusion splicing device;

FIG. 6 functionally depicts an optical fiber fusion splicing device in accordance with an embodiment of the present invention; and

FIGS. 7 and 8 provide logic flow diagrams that describe a method of coupling optical cables in accordance with embodiments of the present invention.

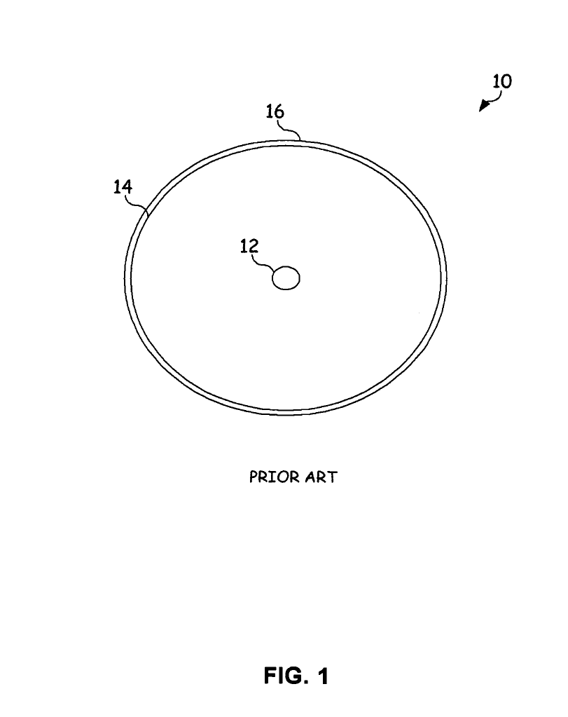

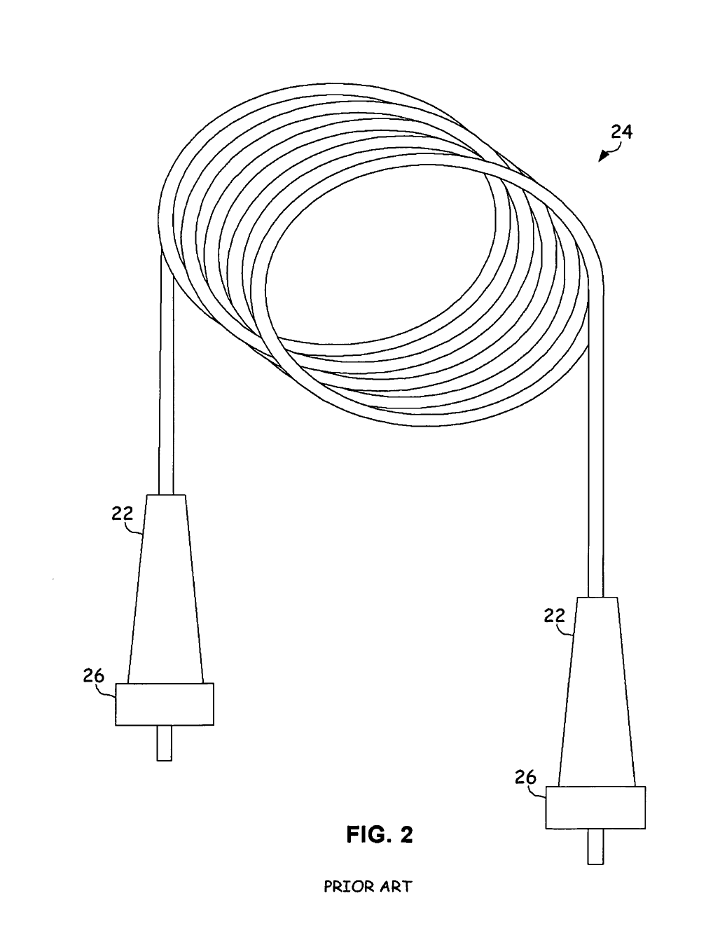

### DETAILED DESCRIPTION OF THE INVENTION

Preferred embodiments of the present invention are illustrated in the FIGS., like numerals being used to refer to like and corresponding parts of the various drawings.

With any system employing fiber optics, any splice is potentially the weakest link. A proper splice may attenuate the signal only slightly. However, a poor splice can leak light, reflect a signal back on a transmission path, or separate completely often requiring an expensive troubleshooting and repair. A splice is a direct permanent connection between two optical fiber ends. As with electrical connections, optical fibers may be used at length to an existing fiber or repair a broken or damaged fiber. How unlike electrical splices, which only require clean contact between two pieces of wire, optical splices require a great deal of precision and careful preparation of the fiber ends if they are to be spliced properly. The fibers cores must align precisely to prevent any loss of light across the splice. There are a number of factors at work that affect the properties in the splice. These may be divided into intrinsic factors that relate to the actual structure of the fiber and extrinsic factors which concern the relationship of one fiber to another.

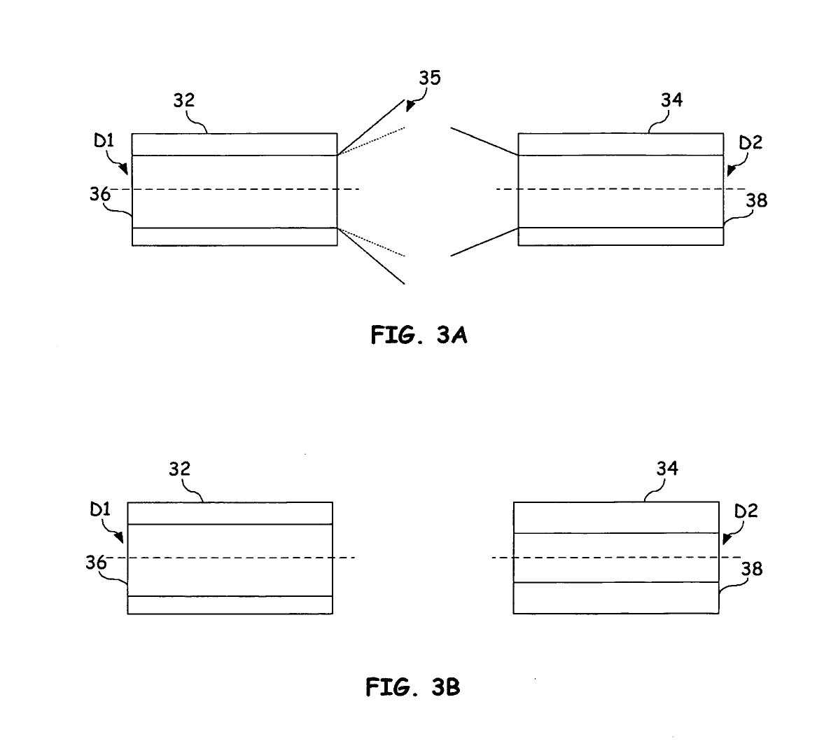

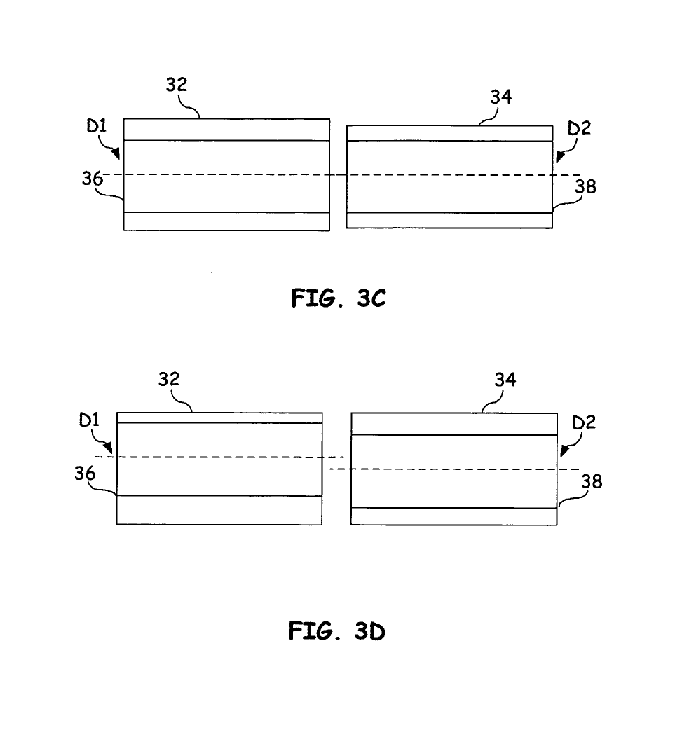

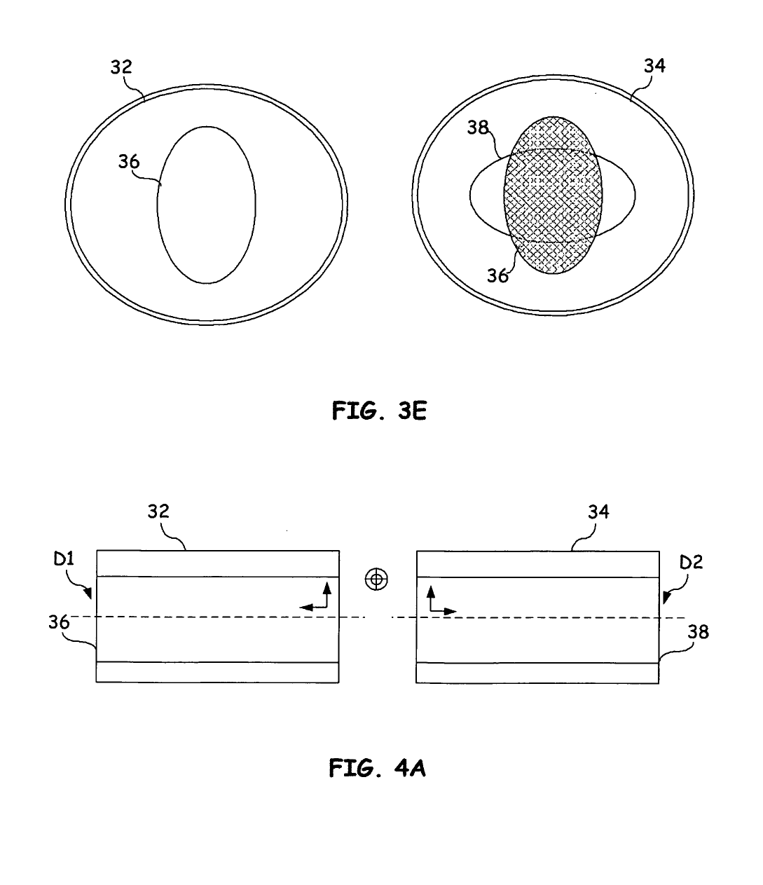

FIGS. 3A through 3E depict many intrinsic factors which may affect the splice. Individual fibers may exhibit slight variations. These variations can cause mismatches between the two fiber ends. FIG. 3A depicts a numerical aperture mismatch loss which occurs when the numerical aperture of transmitting fiber 32 is larger than that of receiving fiber 34. Because the numerical aperture is determined by the refractive indices of the core and cladding, it is possible for two fibers to have the same size and still result in a numerical aperture mismatch. In such a case, some of the light needed in region 36 is lost into the cladding of the receiving fiber.

FIG. 3B depicts an instance where cores 36 and 38 of transmitting fiber 32 and receiving fiber 34 respectively have differing diameters. Light loss occurs when the light at the outer edge of the transmitting core 36 falls outside the diameter of receiving core 38 and is absorbed in the cladding of receiving fiber 34.

FIG. 3C depicts an instance where cladding diameter mismatch loss can occur although the cores of the transmitting fiber at 32 and receiving fiber at 34 are of the same diameter. This typically results in a misalignment of core 36 to core 38.

FIG. 3D depicts an instance where concentricity loses occur as caused by off center fiber cores. As shown in FIG. 3D, core 36 is off center when compared to core 38. Similarly, an elliptical core as shown in the cross sections depicted in FIG. 3E describe how light may be lost into the cladding when the cores' ellipticities do not match.

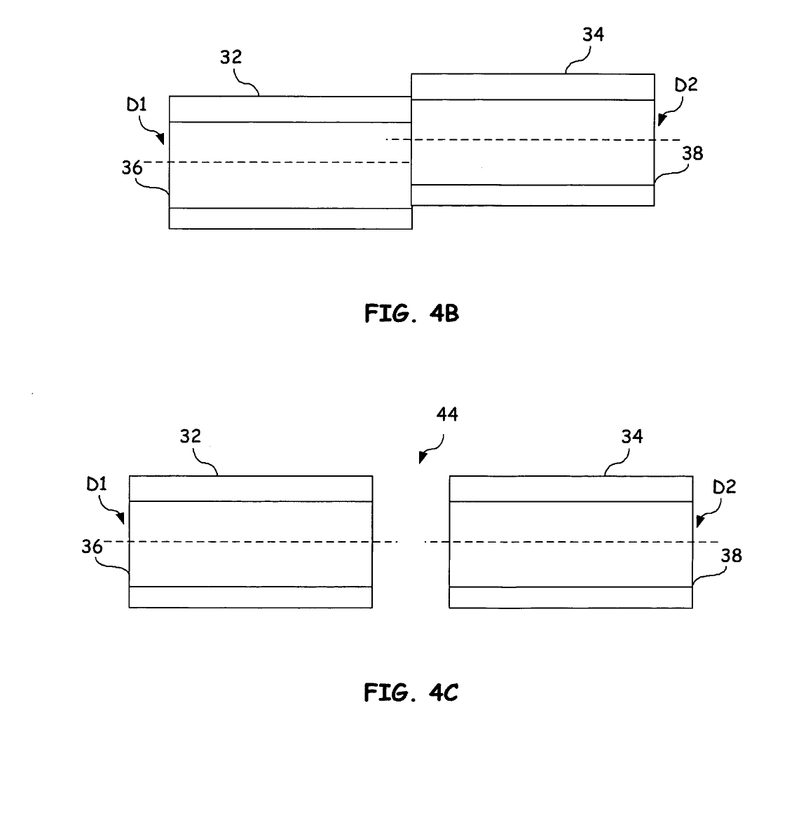

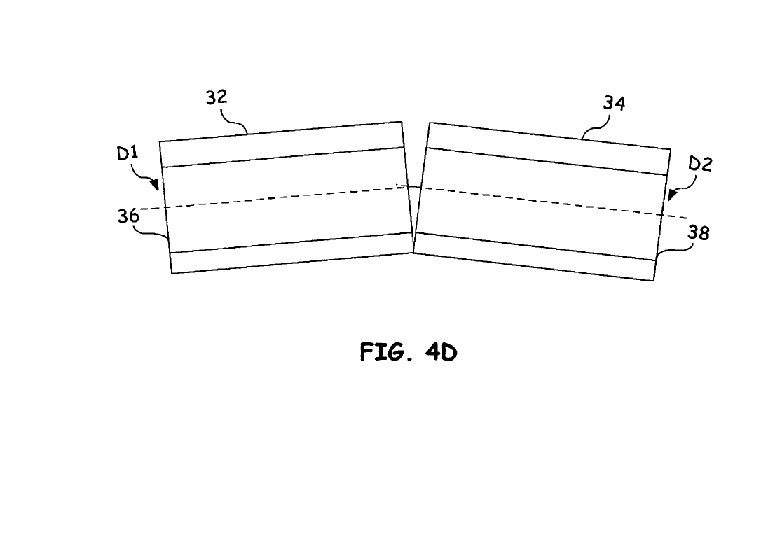

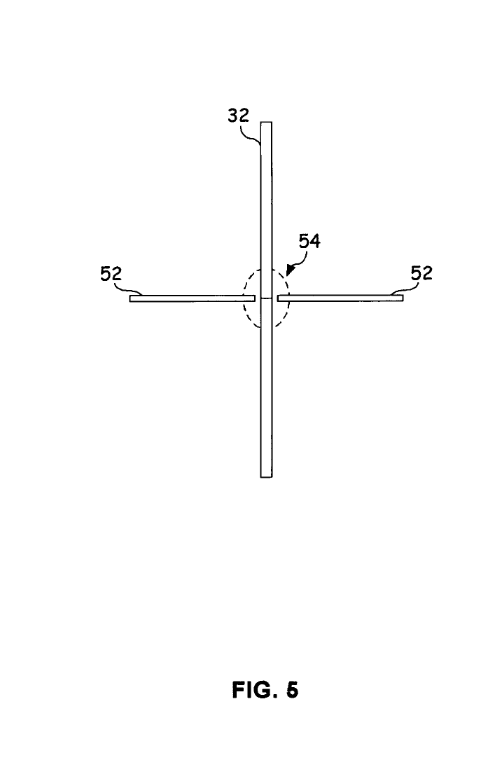

Extrinsic factors that effect attenuation in the splice relate to the condition in the splice itself. In an ideal splice as shown if FIG. 4A, fiber cores 36 and 38 are perfectly centered upon one another and the core axis are perpendicular to the faces being joined. The fiber ends 40 and 42 should be in firm contact. Variation from these conditions can cause attenuation or complete loss of signal. For example, FIG. 4B depicts lateral displacement where fiber cores 36 and 38 are offset from one another's center axis. As lateral displacement increases, less light from transmitting fiber 32 is received within fiber 34. This affect is similar to core diameter mismatch but lateral displacement can occur even when the core diameters are the same. FIG. 4C depicts end separation where even if fibers 32 and 34 are perfectly aligned, they may still experience loss through in separation. This is due to a gap 44 between fibers 32 and 34 as shown. One way of overcoming this is to use an index matching gel. A gel fills the gap and reduces the amount of Fresnel reflection to an acceptable level. In FIG. 4D angular mismatch is depicted. As previously shown in FIG. 4A, an ideal splice requires fiber ends 40 and 42 that are perpendicular to the axis of fiber cores 36 and 38. If fibers 32 and 34 meet at an angle, the signal will suffer losses from angular misalignment as shown in FIG. 4D.

Optical fiber splicing equipment joins two fiber ends permanently with as little loss in optical quality as possible. Mechanical splicers are one type of splicer that uses a plastic tube with a locking mechanism that holds two fibers against each other to make that splice. These are relatively inexpensive but require a permanent fixture to be applied to the splice to hold the fiber ends together. Another type of splicer is a fusion splicer. Fusion splicers create a permanent splice by welding the fiber ends to one another with an electrical arc. Then the splice is enclosed in heat shrink tubing with an oven built into the splicer.

FIG. 5 functionally depicts a fusion splicer where fibers 32 and 34 are placed between electrodes 50 and 52. After welding fibers 32 and 34 together with an electrical arc between electrodes 50 and 52, splice 54 is enclosed within heat shrink tubing 56. These fusion splicers, because of their electrical arc, often require that fiber optics within an aircraft or other volatile environments be completely removed so that the electrical arc cannot interact with any potentially volatile gasses. Fusion splicers may also include microscopes or high-resolution optics in order to properly and accurately place the fiber ends together. In addition to the optics for aligning fiber ends, fusion splicers may also have an alignment mechanism and devices for estimating optical power loss. The alignment mechanism draws the fiber ends together and into a position that optimize their exposure to the welding arc in electrodes 50 and 52 and ensures they are in proper contact for a good splice.

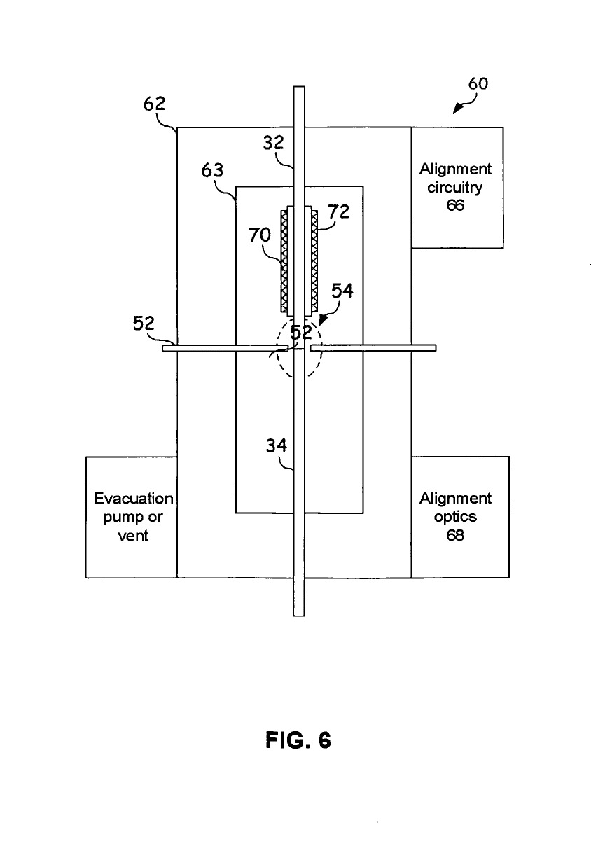

FIG. 6 depicts an embodiment of a fusion splicer in accordance with an embodiment of the present invention. Fusion Splicer 60 has a sealed Chamber 62 that contains a much smaller work envelope than conventional fusion splicing devices. This allows the Fusion Splicer 60 to work in confined volumes, such as aircraft applications, and work site fiber splicing to occur without removing the entire optical harness. Fusion Splicer 60 also contains a re-loadable cartridge 63. Fusion Splicer 60 will receive optical fibers 32 and 34 and place the ends of the optical fibers proximate to electrodes 52. Alignment circuitry 66 or optics 68 may be used to align the optical fibers relative to the electrodes in order to prevent or reduce extrinsic factors which could negatively impact the quality of the splice. The splice will take place with inside sealed chamber 62. Once the fiber has been placed in fusion splicing device 60, device 60 is then sealed through an evacuation process that prevents unwanted gasses from being exposed to the arc used to weld the fibers. Once Compartment 62 has been sealed a technician may then select alignment, fusion, and splice reinforcement operations through a servo/software process.

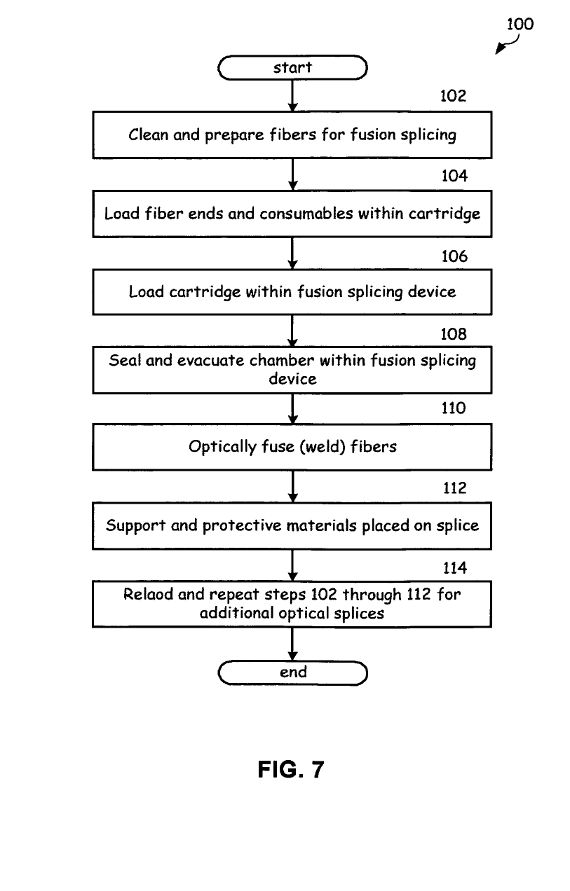

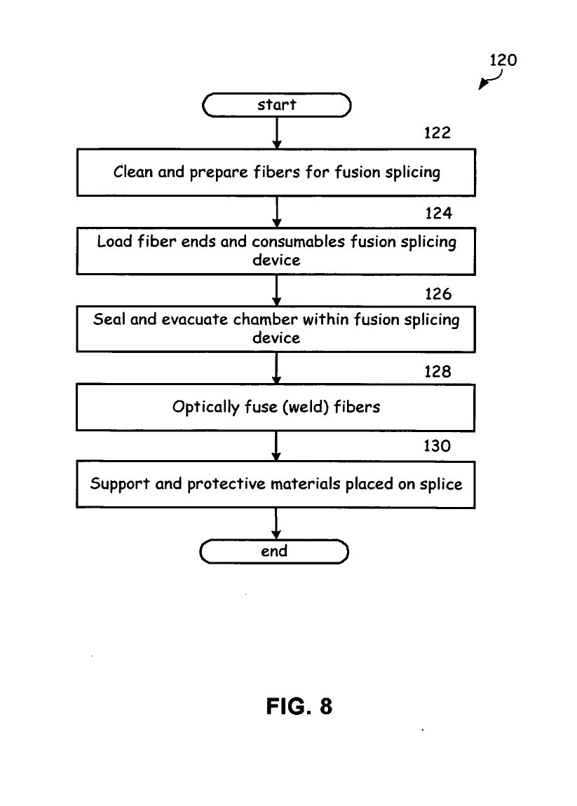

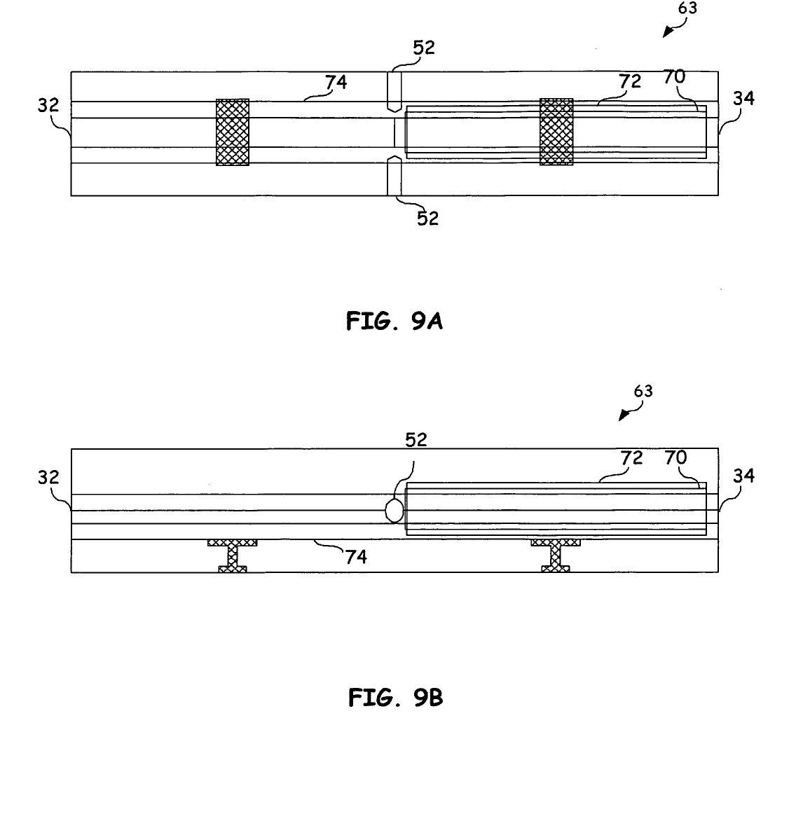

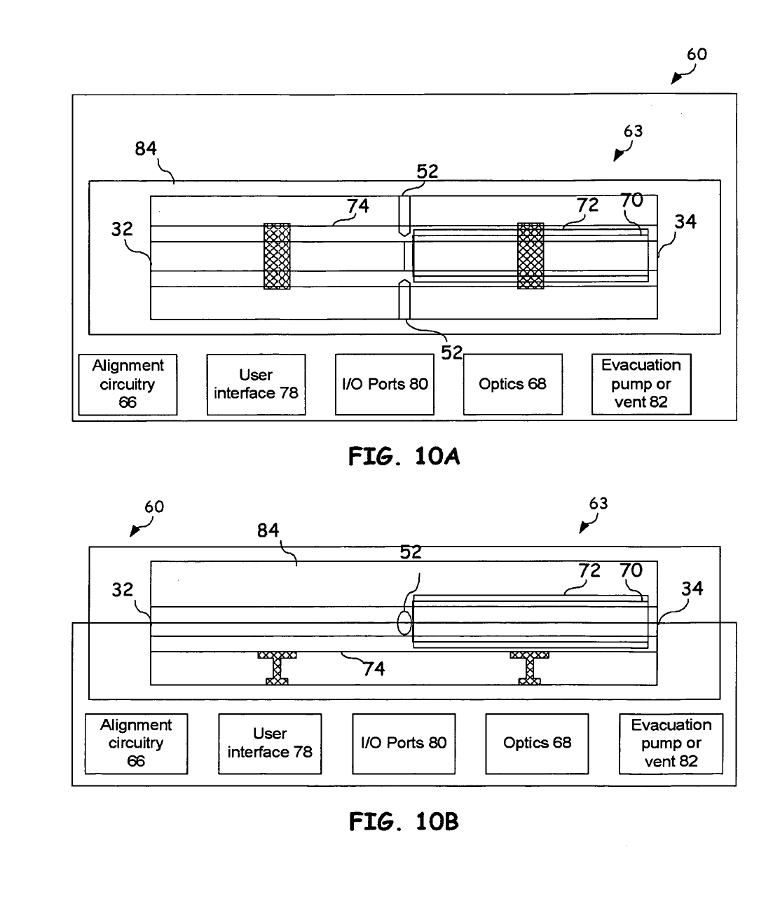

Circuitry 66 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. Memory associated with the circuity may be a single memory device or a plurality of memory devices. Such a memory device may be a read-only memory, random access memory, volatile memory, non-volatile memory, static memory, dynamic memory, flash memory, cache memory, and/or any device that stores digital information. Note that when the processing module 32 implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. The circuitry executes, operational instructions corresponding to at least some of the steps and/or functions illustrated in FIGS. 7 and 8.

Cartridge 62 contains the necessary parts to process the fusion splicing of optical fibers 32 and 34. Additionally a fiber support rod 70 and sleeving 72 may also be contained. Prior to use the Cartridge 62 may be loaded with the respective fiber ends that have been prepared for splicing as well as sleeving and support material for the particular fiber splice. When the cartridge 63 is inserted into Fusion Splicing Device 60, the splicing device 60 will position the loaded fiber ends and optically align the fiber ends to allow maximum power transmission. As this cartridge is re-loadable it will greatly reduce setup and preparation time associated with splicing fibers.

This process eliminates the prior need and time consuming process where in order to repair a damaged fiber within an optical harness the harness was required to be removed to another area where arc dangers associated with the electrodes and fusion process are not present. In other embodiments in place of the two-point electrodes, an Edison coil may be used to fuse the optical fibers.

FIGS. 7 and 8 provide logic-flow diagrams in accordance with embodiments of the precedent invention that describe how optical fibers may be spliced using an optical fusion device.

Operations 100 in FIG. 7 begin with Step 102 where the optical fibers are cleaned and prepared for splicing. In Step 104 the cleaned and prepared fibers are loaded within a cartridge. The cartridge may then be loaded within the fusion device in Step 106. The fusion device may then be sealed and evacuated in Step 108. With the cartridge in place and the chamber evacuated optical fibers may be aligned manually or automatically depending on the specifics of the individual fusion splicing device. In Step 110 the actual splice will take place following alignment. This may be done using an arc or an ensign coil or other like means to heat up and weld optical fibers together. In Step 112 materials to support and protect the splice are placed over the weld. This may be small metallic rods which may be used to support the splice and heat shrink material to provide a protective coat covering of the outside of the splice. In Step 114 the fusion splicing device may be reloaded with a second cartridge and associated optical fibers to repeat Splicing Operations 106 through 112.

FIG. 8 provide provides a logic-flow diagram in accordance with another embodiment of the present invention describing a method splicing optical fibers using the fusion splicing device in confined areas. Operations 120 begin with Step 122 where the optical fibers to be spliced are cleaned and prepared. In Step 124 the fibers and other consumables such as a protective sleeve and support materials may be loaded within the fusion splicing device. Once these materials are loaded within the fusion splicing device, the fusion splicing device may be sealed and the chamber evacuated in step 126. Evacuating the chamber or filling the chamber with an inert gas allows the fusion splicing device to operate in confined areas or areas having potentially volatile gases. In Step 128 the actual splice will take place following alignment. This may be done using an arc, Edison coil or other like means to heat up and weld the optical fibers together. In Step 130 the consumable materials used to support and protect the splice are placed over the weld.

FIGS. 9A and 9B provide a top-down and cross-sectional view of the loadable cartridge 63. This re-loadable cartridge can receive optical fibers 32 and 34 within a cradle 74 supported by supports 76. Cartridge 52 is proximate to the splice to be welded between the optical fibers 32 and 34. Protective material 72 and sheathing 70 may be slid into place to protect the weld after the weld has been fused.

FIGS. 10A and 10B provide a top-down and side view of a fiber fusion splicing device 60 in accordance with embodiments of the present invention. This fiber fusion splicing device 60 may receive cartridge 63. Cartridge 63 has been previously described with respect to FIGS. 9A and 9B. Cartridge 63 may be received within an internal chamber 84 which may be evacuated or filled with an inert gas in order to protect to allow the optical welding using an arc or other like means to fuse optical fibers 32 and 34. Once Cartridge 63 has been placed within internal chamber 84, alignment circuitry may align optical fibers 32 and 34. This may be done manually through use of user interface 78 or automatically using an internal processor. A technician may additionally use optic 68 to verify the alignment. Data recording devices and circuitry coupled to the fiber fusion splicer, splicing device 60 may allow quality assurance information associated with the optical weld to be recorded for further analysis. Additionally, aisle port 80 not only allows that data to be transferred to an external processing system but aisle port 80 may allow the fiber fusion splicing device 60 to be quickly set up for various fibers, sizes and types and other parameters associated with the optical weld.

The embodiments of the present invention have the ability to allow splicing of optical fiber when a contact has to be replaced or when a fiber is damaged in the aircraft harness, without complete removal of the harness. Embodiments of the present invention also allow technicians to work in a confined area; which is one of the more preclusive issues which prevents the use of conventional fusion splicing devices due to size and dangers involved with the use of an arcing mechanism. Where optical fiber and the tools to use and build products using optical fiber is concerned, the industry is not well served to design needs beyond that of the telecom industry.

The removable, replaceable, reloadable, optical alignment and fiber fusion splice processing cartridge allows the technician to simply feed the end of the prepared fiber and the segment to be spliced into the cartridge from each end. When this cartridge is inserted into the optical fiber fusion splice device the cartridge contains the parts (i.e. consumables) necessary to the process of fiber alignment for fusion splicing (two pieces of optical fiber, and subsequent fiber support rod or tube and sleeving application thereafter). Prior to use, the cartridge will be loaded with an optical fiber splice sleeve, the respective fiber ends that have been prepared for splicing; as well as the sleeving and support materials designated for the particular fiber being spliced. When the cartridge is inserted into the optical fiber fusion splice device, the splice device will position the loaded fiber ends and optically align the fiber ends to allow maximum power output when optimally aligned, then the optical fiber fusion splice device will complete the fusion splice and sleeving process within the cartridge. Upon completion of the process this cartridge will be reloadable. As it is a removable device, the cartridge can be removed and replaced by a second preloaded cartridge of the same type. Cartridges can vary as to application specifics including material for the variance that exist between heated processes and withstand capabilities governed by optical fiber design and make-up.

Embodiments of the present invention reduce or eliminate the need for the complete removal of the harness to a safe environment. This allows a quicker more efficient manpower/man-hour application process that results in a direct savings. Using a Cartridge, which loads and is either dispensable or reloadable depending on the number of applications in which the cartridge has been used, the efficiency of fiber splicing in aircraft applications (production or retrofit/repair) will be increased dramatically, with future affects on resultant cost savings. This device will provide the ability to safely use a fusion process around an aircraft without past volatile issues, such as aircraft fuel fumes, or their affect on the resultant optical weld. When Embodiments of the present invention are used the process can also improve dependability and repeatability due to the controlled actions that are designed into this device.

Although the present invention is described in detail, it should be understood that various changes, substitutions and alterations can be made hereto without departing from the spirit and scope of the invention as described by the appended claims.

What is claimed is:

1. An optical fiber fusion splicing system, comprising:
a receiving mechanism operable to receive a first optical fiber and second optical fiber;
an internal chamber operable to isolate the optical fibers from an external environment;
alignment circuitry operable to align the first optical fiber to the second optical fiber; and
a welding module operable to fuse the aligned optical fibers.

2. The optical fiber fusion splicing system of claim 1, wherein the welding module fuses the aligned optical fibers with an arc between a first and second electrode.

3. The optical fiber fusion splicing system of claim 1, wherein the welding module fuses the aligned optical fibers with an Edison coil.

4. The optical fiber fusion splicing system of claim 1, further comprising an evacuation system operable to evacuate gases from the internal chamber prior to fusing the aligned optical fibers.

5. The optical fiber fusion splicing system of claim 1, further comprising an evacuation system operable to evacuate gases from the internal chamber prior to fusing the aligned optical fibers.

6. The optical fiber fusion splicing system of claim 1, further comprising an evacuation system is operable to fill the internal chamber with an inert gas prior to fusing the aligned optical fibers.

7. The optical fiber fusion splicing system of claim 1, further comprising a cartridge receiving mechanism, wherein the optical fibers and fusion consumables are loaded within a cartridge received by the cartridge receiving mechanism.

8. The optical fiber fusion splicing system of claim 7, wherein the alignment circuitry aligns the optical fibers within the cartridge.

9. A method to splice optical fibers, comprising:
preparing a first optical fiber and second optical fiber to be spliced;
receiving the first optical fiber and second optical fiber to be spliced within an internal chamber of a fiber fusion splicing device;
isolating the internal chamber from an external environment;
aligning the first optical fiber and second optical fiber to be spliced; and
optically welding the first optical fiber to the second optical fiber.

10. The method of claim 9, the method further comprising:
reinforcing the optical weld between the first optical fiber to the second optical fiber; and
placing a protective sleeving over the optical weld between the first optical fiber to the second optical fiber.

11. The method of claim 9, wherein isolating the internal chamber from an external environment comprises evacuating the internal chamber.

12. The method of claim 9, wherein isolating the internal chamber from an external environment comprises filling the internal chamber with an inert gas.

13. The method of claim 9, wherein aligning the first optical fiber and second optical fiber to be spliced comprises automatically aligning the optical fibers with alignment circuitry.

14. The method of claim 9, wherein optically welding comprises fusing the aligned optical fibers with an arc between a first and second electrode.

15. The method of claim 9, wherein optically welding comprises fusing the aligned optical fibers with an Edison coil.

16. The method of claim 9, wherein the optical fibers, and fusion consumables are loaded within a cartridge received by the fiber fusion splicing device.

17. A cartridge operable to facilitate splicing optical fibers, the cartridge comprising:
a receiving mechanism operable to receive a first optical fiber and second optical fiber;
alignment circuitry operable to align the first optical fiber to the second optical fiber; and
consumables used to fuse the aligned optical fibers.

18. The cartridge of claim 17, wherein the consumables comprise:
reinforcing materials operable to support the optical weld between the first optical fiber to the second optical fiber; and
protective sleeving operable to protect the optical weld between the first optical fiber to the second optical fiber.

19. The cartridge of claim 17, wherein the cartridge is operable to be received within a fiber fusion splicing device.

20. The cartridge of claim 19, wherein the alignment circuitry interfaces with an alignment module of the fiber fusion splicing device.
